(19) United States
(12) Patent Application Publication
(10) Pub. No.: US 2017/0235463 A1
(43) Pub. Date: Aug. 17, 2017

(54) DISPLAY CONTROL METHOD, NON-TRANSITORY COMPUTER READABLE MEDIUM STORING DISPLAY CONTROL PROGRAM, AND TERMINAL DEVICE

(71) Applicant: FUJITSU LIMITED, Kawasaki-shi (JP)

(72) Inventor: Yoshihiko Nishida, Kawasaki (JP)

(73) Assignee: FUJITSU LIMITED, Kawasaki-shi (JP)

(21) Appl. No.: 15/358,654

(22) Filed: Nov. 22, 2016

(30) Foreign Application Priority Data
Feb. 16, 2016 (JP) 2016-027442

(51) Int. Cl. G06F 3/0484; G06F 3/0485

(52) U.S. Cl. CPC G06F 3/04845; G06F 3/0485; G06F 3/04842; G06F 3/04883

(57) ABSTRACT

A display control method implemented by a computer, the method includes: receiving a designation of one or more data from a group of data available in a first application; creating a screen area including information associating each of the one or more data with a corresponding area, and displaying the screen area on a forefront surface of a display; receiving a call operation of a second application, and displaying a screen of a second application on a rear side of the screen area while maintaining the screen area displayed on the forefront surface; and inputting to the second application, when a predetermined operation to the screen area displayed on the forefront surface is detected, the data associated with the screen area from which the predetermined operation is detected.

### CROSS-REFERENCE TO RELATED APPLICATION

This application is based upon and claims the benefit of priority of the prior Japanese Patent Application No. 2016-027442, filed on Feb. 16, 2016, the entire contents of which are incorporated herein by reference.

### FIELD

A certain aspect of embodiments described herein relates to a display control method, a non-transitory computer readable medium storing a display control program, and a terminal device.

### BACKGROUND

Whenever an application program (hereinafter simply referred to as “an application”) is executed in a touch panel which a smartphone includes, the whole screen may be switched and displayed. For example, both of the whole screen of a first application and the whole screen of a second application cannot be displayed at the same time, and any one of the whole screens is displayed by switching.

On the contrary, there has been known an operation method that fixes a part of display contents displayed in a screen and scrolls an area other than the fixed part, in a touch panel that a cell phone includes (Patent Document 1: Japanese Patent Application Publication No. 2011-242820). In the operation method, a user first touches a certain position in the screen displayed on the touch panel by a middle finger once. An area including a first contact point touched by the middle finger is determined as a fixed area, a touched state is stably maintained, and the part of the display contents is fixed. Next, the user touches a position different from the above-mentioned position by an index finger and drags the index finger vertically downward by a prescribed distance. An area including a second contact point touched by the index finger is determined as a non-fixed area, and the display contents are scrolled.

### SUMMARY

According to an aspect of the present invention, there is provided a display control method implemented by a computer, the method including: receiving a designation of one or more data from a group of data available in a first application in a state where the first application has been started up; creating a screen area including information associating each of the one or more data with a corresponding area, and displaying the screen area on a forefront surface of a display; receiving, after the screen area is displayed on the forefront surface, a call operation of a second application, and displaying a screen of a second application on a rear side of the screen area while maintaining the screen area displayed on the forefront surface; and inputting to the second application, when a predetermined operation to the screen area displayed on the forefront surface is detected in a state where the screen of the second application is displayed, the data associated with the screen area from which the predetermined operation is detected.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of an information processing system;

FIG. 2 is a diagram illustrating a hardware configuration of a terminal device;

FIG. 3 is a block diagram illustrating an example of the terminal device and a server;

FIG. 4 is a flowchart illustrating an example of a process executed by the terminal device;

FIG. 5 is a diagram illustrating an example of a long depression operation to a screen of a first application;

FIG. 6 is a diagram illustrating an example of a screen area;

FIG. 7 is a diagram illustrating an example of a floating state;

FIG. 8 is a diagram illustrating an example of a drag operation to the screen area;

FIG. 9 is a diagram illustrating an example of a touch operation to the screen of the first application;

FIG. 10 is a diagram illustrating another example of the drag operation to the screen area;

FIG. 11 is a diagram illustrating an example of the long depression operation to the screen area;

FIG. 12 is a diagram illustrating an example of the screen of a second application;

FIG. 13 is a diagram illustrating an example of the touch operation to the screen area;

FIG. 14 is a diagram illustrating another example of a screen of the second application; and

FIG. 15 is a diagram illustrating an example of a semitransparent screen area.

### DESCRIPTION OF EMBODIMENTS

In the above-mentioned smartphone, when the user wants to input data available in the first application as a processing object of the second application, an operation which takes much labor for the user may be required. More practically, when the user wants to input an E-mail available in a reception tray application managing a received mail as a processing object of an application creating a new E-mail, the user may be required to perform an operation to specify the E-mail to be processed and an operation to switch the screen between the two applications.

Hereinafter, a description will be given of an embodiment with reference to drawings.

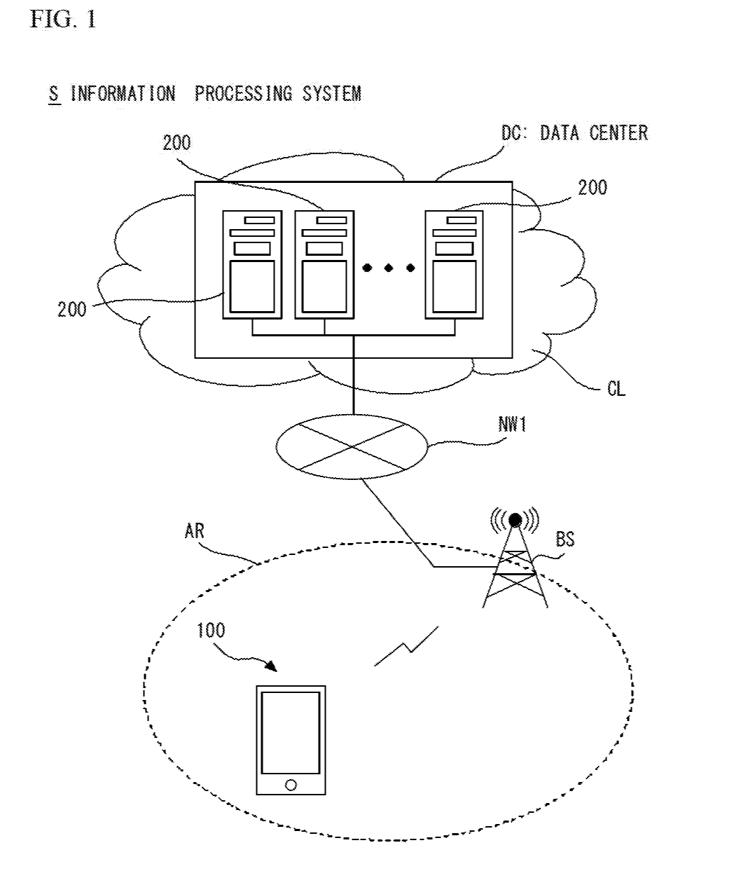

FIG. 1 is a diagram illustrating an example of an information processing system S. The information processing system S includes a terminal device 100 and a server 200. FIG. 1 illustrates a smartphone as an example of the terminal device 100, but the terminal device 100 is not limited to the smartphone if it is a portable information terminal. The terminal device 100 may be a smart device such as a smart watch, a tablet terminal, a wearable computer or the like.

The terminal device 100 and the server 200 are connected to each other via a wired network NW1 and a wireless network described later. The wired network NW1 is a communication network such as an Internet, for example. The wireless network is a communication network such as a portable phone network, for example. Therefore, when the terminal device 100 is included in an area AR enabling a wireless communication, the terminal device 100 can communicate with the server 200.

The terminal device 100 receives various information transmitted from the server 200 and transmits various information to the server 200. When the terminal device 100 transmits a browsing request for requesting browsing of an electronic file to the server 200 storing a plurality of electronic files, for example, the server 200 receives the browsing request.

More particularly, a base station BS receives the browsing request transmitted from the terminal device 100 via the wireless network. The base station BS transfers the received browsing request to the server 200. The server 200 receives the browsing request transferred by the base station BS via the wired network NW1. When the server 200 receives the browsing request, the server 200 permits the terminal device 100 to browse the electronic file. When the server 200 receives an acquisition request of the electronic files from the terminal device, the server 200 may transmit a list of the electronic files and each corresponding electronic file to the terminal device 100 in accordance with the acquisition request.

The above-mentioned electronic files include program files, data files and the like, for example. The data files include a document file including document data, an image file including a moving image or a still image, a sound file including sound data, an E-mail including text data and the like, for example. In FIG. 1, the server 200 is provided in a data center DC on a cloud CL. For example, when the base station BS is changed to an access point and a local area network (LAN) is used as the wired network NW1, the server 200 may be connected to the LAN.

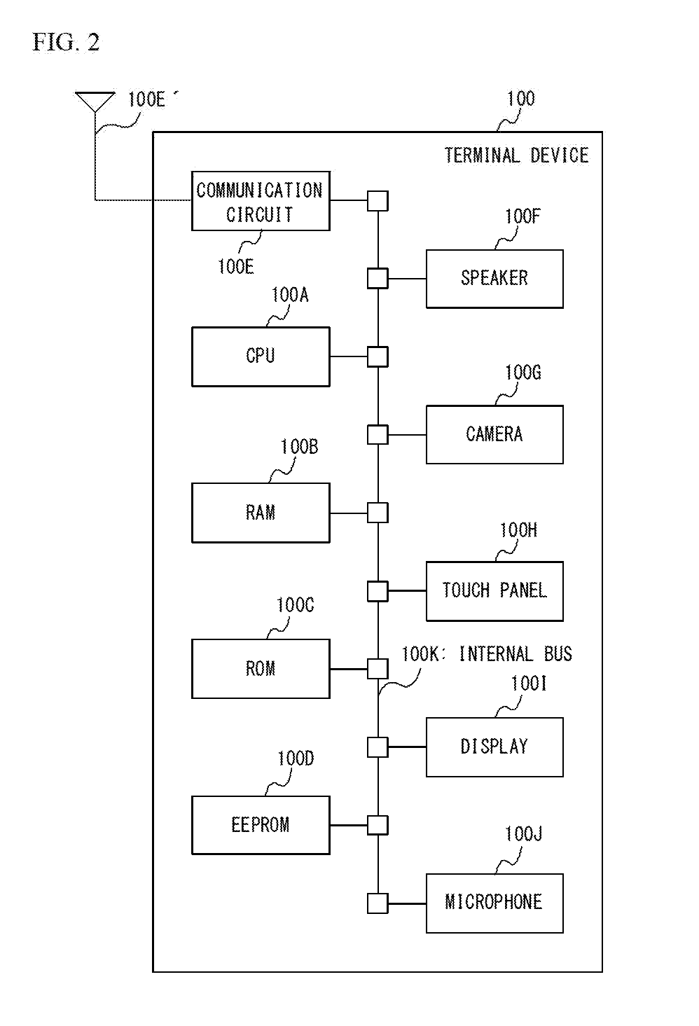

Next, a description will be given of a hardware configuration of the terminal device 100 with reference to FIG. 2. Here, the above-mentioned server 200 basically has the same configuration as the terminal device 100, and a description thereof is therefore omitted.

FIG. 2 is a diagram illustrating the hardware configuration of the terminal device 100. As illustrated in FIG. 2, the terminal device 100 includes a Central Processing Unit (CPU) 100A, a Random Access Memory (RAM) 100B, a Read Only Memory (ROM) 100C, an Electrically Erasable Programmable Read Only Memory (EEPROM) 100D and a communication circuit 100E. An antenna 100E′ is connected to the communication circuit 100E. A CPU that achieves a communication function may be used as substitute for the communication circuit 100E.

Moreover, the terminal device 100 includes a speaker 100F, a camera 100G, a touch panel 100H, a display 100I and a microphone 100J. The camera 100G includes an imaging element using a Complementary Metal Oxide Semiconductor (CMOS) or a Charge Coupled Device (CCD), and an optical system such as a lens. The CPU 100A to the microphone 100J are connected to each other via an internal bus 100K. At least the CPU 100A and the RAM 100B cooperate with each other, so that a computer is achieved.

A program stored into the ROM 100C or the EEPROM 100D is stored into the above-mentioned RAM 100B by the CPU 100A. The CPU 100A executes the stored program, so that various functions described later are achieved and various processes are performed. Here, the program needs to correspond to a flowchart described later.

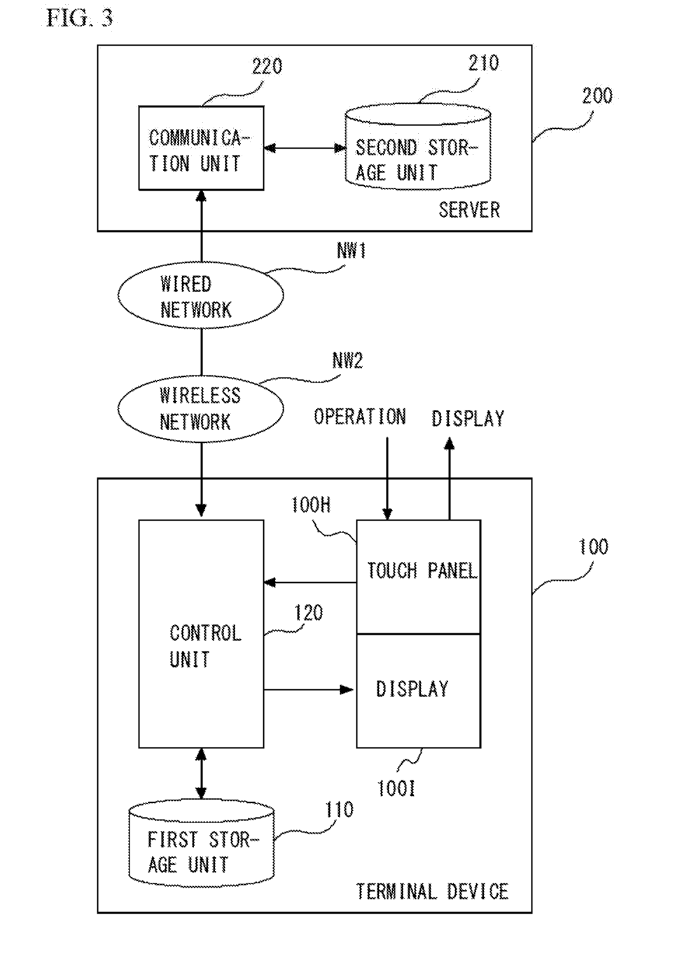

Next, a description will be given of each function of the terminal device 100 and the server 200 with reference to FIG. 3.

FIG. 3 is a block diagram illustrating an example of the terminal device 100 and the server 200. The terminal device 100 includes a first storage unit 110 and a control unit 120. The server 200 includes a second storage unit 210 and a communication unit 220. Here, the touch panel 100H and the display 100I are hardware and are illustrated by a dotted line. First, a description will be given of the terminal device 100, and next a description will be given of the server 200.

The first storage unit 110 stores the plurality of electronic files. As described above, the electronic files include program files, data files and the like, for example. The data files include the document file, the image file, the sound file, the E-mail and the like, for example. The first storage unit 110 stores the E-mail received via the above-mentioned communication circuit 100E, for example. The first storage unit 110 stores moving image data or still image data captured by the above-mentioned camera 100G as the image file, for example. The first storage unit 110 stores sound data acquired from the above-mentioned microphone 100J as the sound file, for example. Here, the first storage unit 110 corresponds to the above-mentioned EEPROM 100D or the like, for example.

The control unit 120 receives a long depression operation designating one or more data from a group of data available in the first application from a user via the touch panel 100H in a state where the first application has been started up. The group of data includes a plurality of data files stored into the above-mentioned first storage unit 110 or the second storage unit 210 mentioned later. Moreover, the group of data includes a plurality of pieces of character data or a plurality of pieces of character string data when the first application supports the creating of the document. The long depression operation indicates touching the designated object for a given period or more. The long depression operation is a long tap operation, for example.

Moreover, the control unit 120 creates an opaque screen area including association information associating each of one or more data designated by the long depression operation with a corresponding area, and displays the opaque screen area on a forefront surface of the display 100I. More specifically, after creating the screen area, the control unit 120 sets the opaque screen area to a floating state keeping the display thereof, and displays the opaque screen area on the forefront surface of the display 100I. Here, since an operable area in the touch panel 100H is transparent, the touch panel 100H displays a screen area that is displayed on the display 100I and arranged under the operable area. Therefore, the user can view the screen area. For the same reason, the touch panel 100H displays the screen of the first application that is displayed on the display 100I and arranged under the operable area. Similarly the touch panel 100H also displays the screen of the second application mentioned later. When the screen area is set to the floating state, the screen area is always displayed on the forefront surface as if it floats from the screen of the first application or the second application, and becomes movable.

Moreover, after displaying the above-mentioned screen area on the forefront surface, the control unit 120 receives a call operation calling the second application from the user via the touch panel 100H. The control unit 120 displays a screen of the second application on a rear side of the screen area while the screen area is being displayed on the forefront surface.

When the control unit 120 receives a predetermined operation to the screen area displayed on the forefront surface from the user via the touch panel 100H in a state where the screen of the second application is displayed, the control unit 120 detects the predetermined operation, and inputs data associated with the screen area from which the predetermined operation is detected, to the second application as the process object. That is, the predetermined operation corresponds to an instruction to stick the data on the screen of the second application. The predetermined operation is a touch operation (e.g. a tap operation) that touches the designated object for a period shorter than the given period, or the above-mentioned long depression operation. Here, the control unit 120 corresponds to the CPU 100A, the RAM 100B and the communication circuit 100E or the like, for example.

The second storage unit 210 stores a plurality of electronic files. The contents of the electronic files are basically the same as those of the electronic files stored into the first storage unit 110. The second storage unit 210 stores the E-mail in addition to the document file, the image file and so on transmitted via the communication circuit 100E, for example. Here, the second storage unit 210 corresponds to a Hard Disk Drive (HDD) or the like, for example.

The communication unit 220 communicates with the control unit 120. When the above-mentioned browsing request is transmitted from the control unit 120, for example, the communication unit 220 receives the browsing request by way of the wireless network NW2 and the wired network NW1. When the communication unit 220 receives the browsing request, the communication unit 220 permits the terminal device 100 to browse the electronic files stored into the second storage unit 210. When the above-mentioned acquisition request is transmitted from the control unit 120, for example, the communication unit 220 receives the acquisition request by way of the wireless network NW2 and the wired network NW1. When the communication unit 220 receives the acquisition request, the communication unit 220 extracts the electronic file corresponding to the acquisition request from the electronic files stored into the second storage unit 210 and transmits the extracted electronic file to the control unit 120. The communication unit 220 corresponds to a CPU, a RAM, a communication circuit and so on included in the server 200, for example.

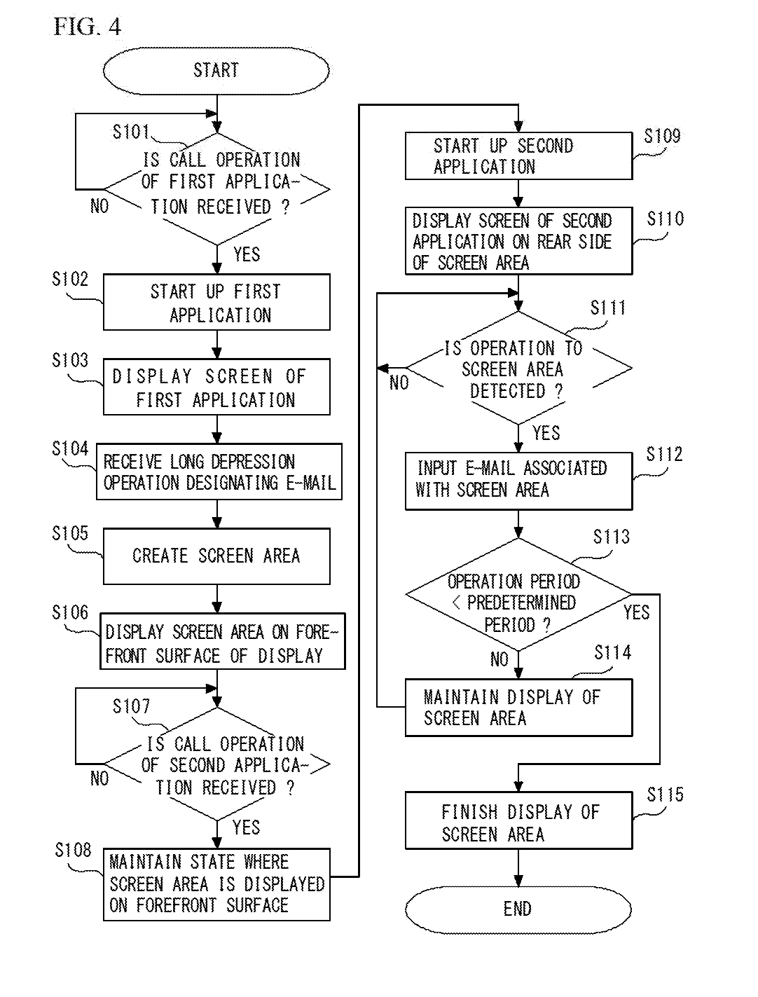

Next, a description will be given of the actuation of the terminal device 100 with reference to FIGS. 4 to 14.

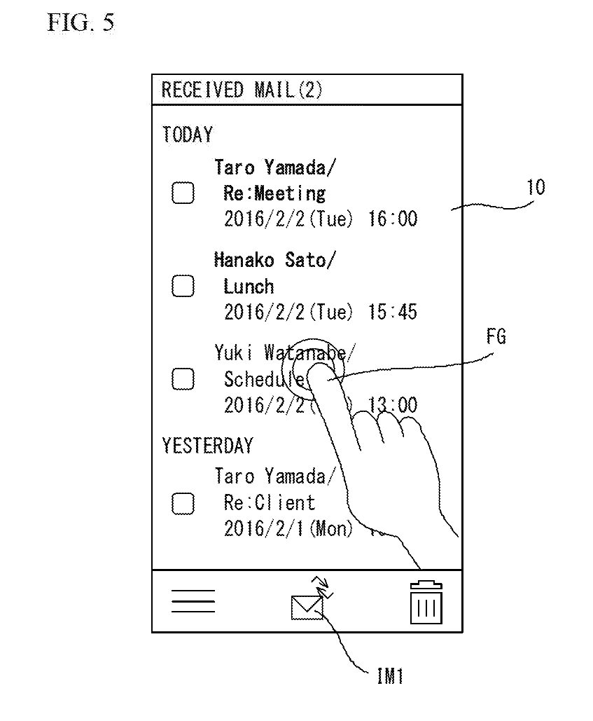

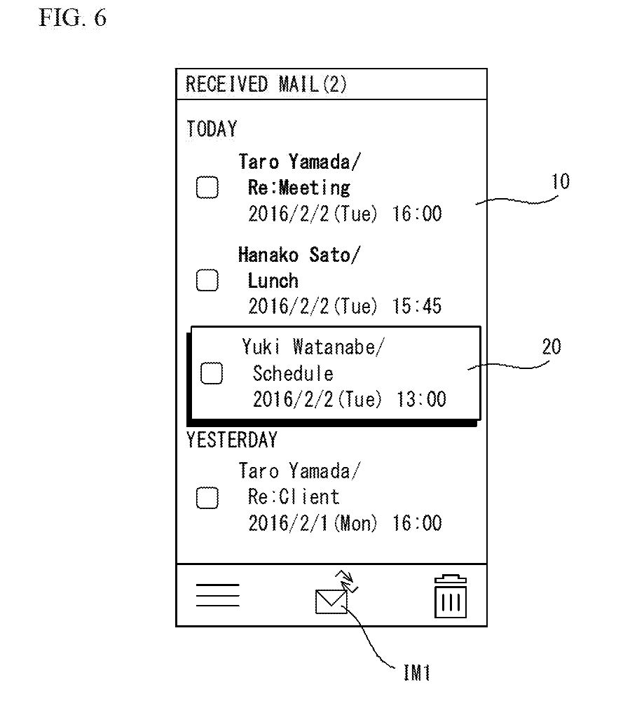

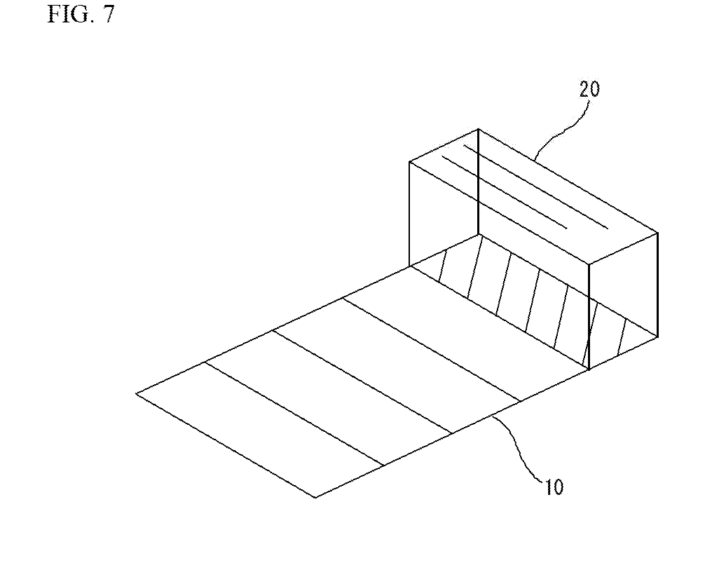

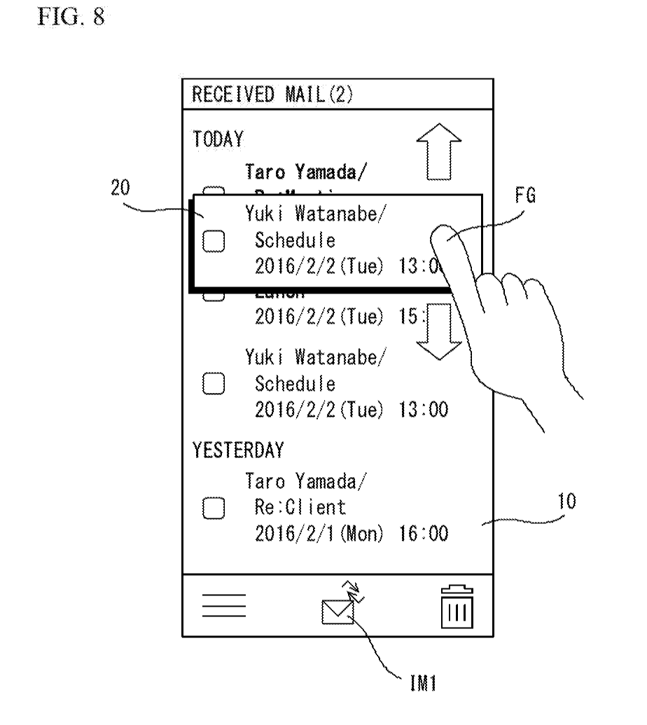

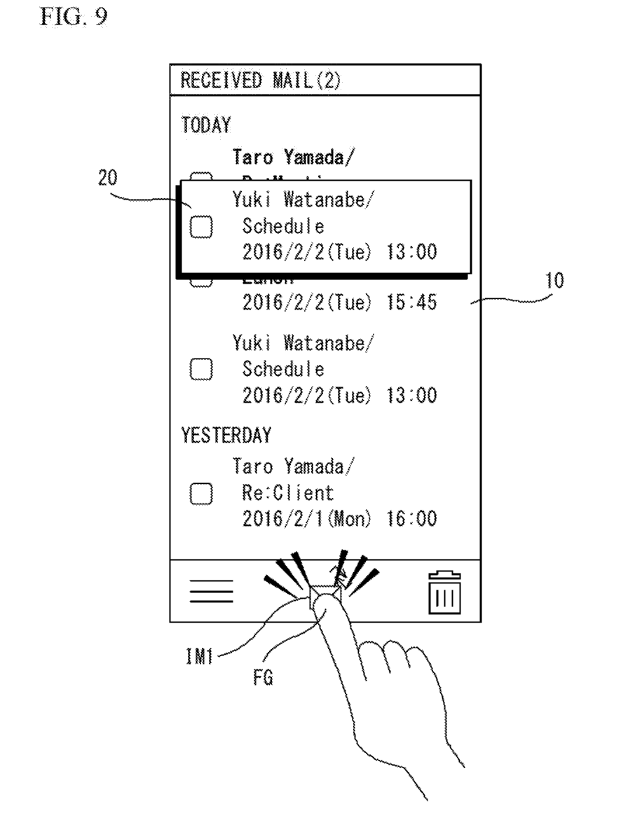

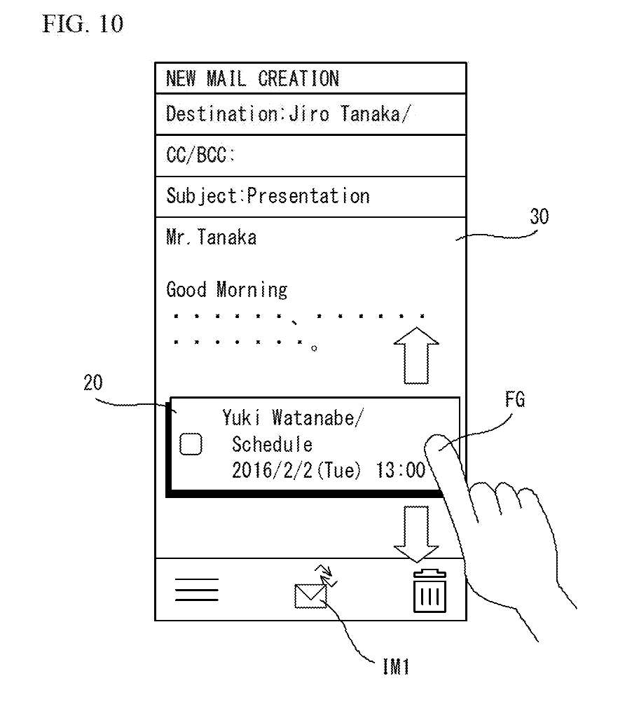

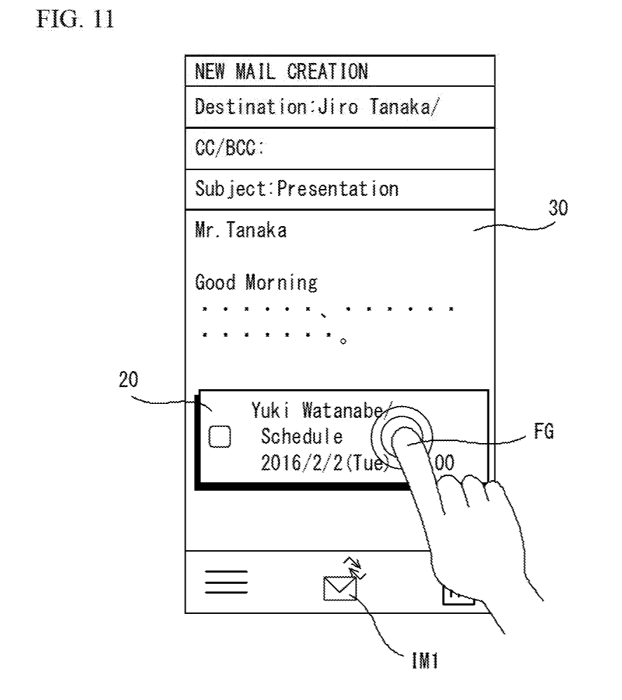

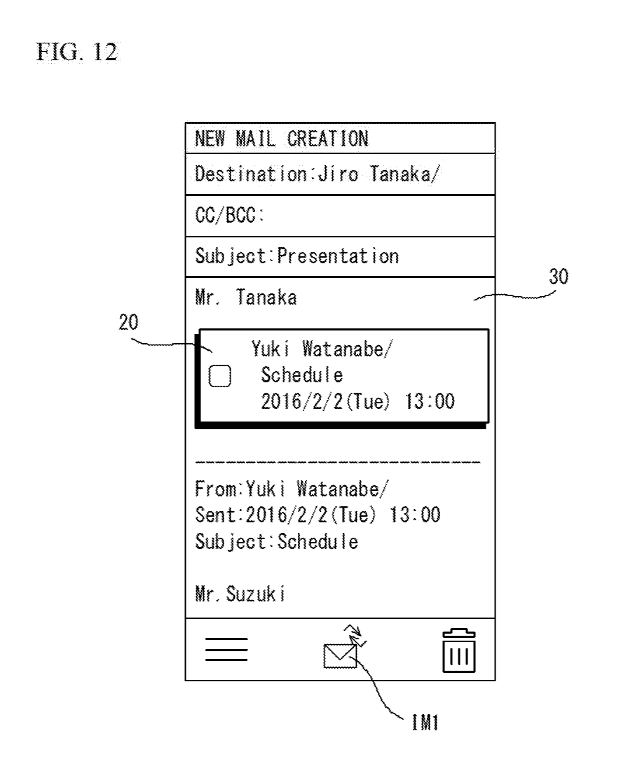

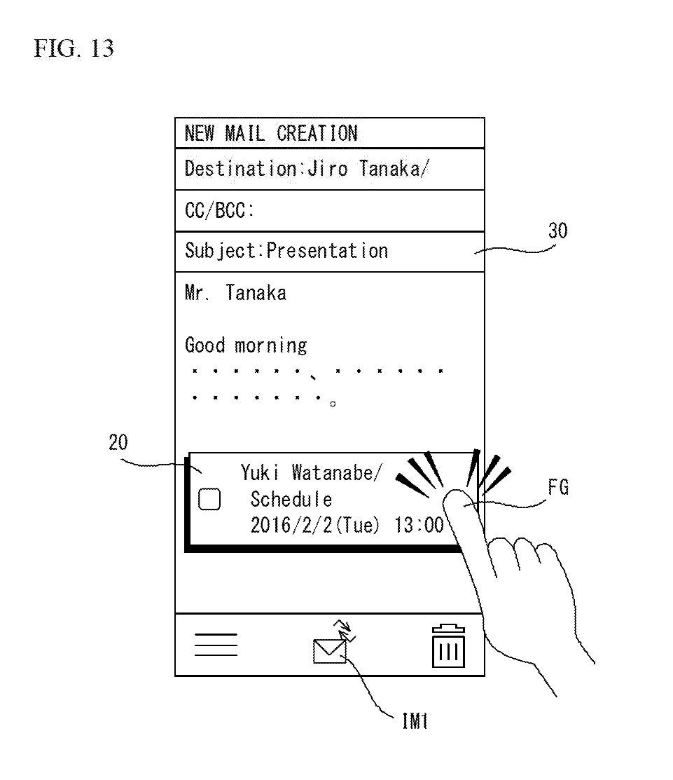

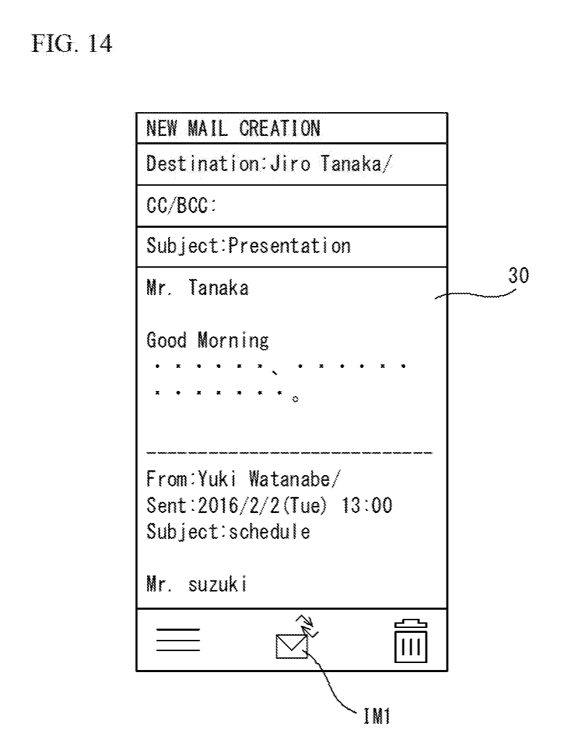

FIG. 4 is a flowchart illustrating an example of a process executed by the terminal device 100. FIG. 5 is a diagram illustrating an example of a long depression operation to a screen 10 of a first application. FIG. 6 is a diagram illustrating an example of a screen area 20. FIG. 7 is a diagram illustrating an example of the floating state. FIG. 8 is a diagram illustrating an example of a drag operation to the screen area 20. FIG. 9 is a diagram illustrating an example of a touch operation to the screen 10 of the first application. FIG. 10 is a diagram illustrating another example of the drag operation to the screen area 20. FIG. 11 is a diagram illustrating an example of the long depression operation to the screen area 20. FIG. 12 is a diagram illustrating an example of a screen 30 of a second application. FIG. 13 is a diagram illustrating an example of the touch operation to the screen area 20. FIG. 14 is a diagram illustrating another example of the screen 30 of the second application.

Hereinafter, a description will be given of a case where the E-mail managed by the first application achieving a reception tray is input as a citation object of the second application creating a new E-mail, as an example. However, the process object is not particularly limited to the E-mail. For example, photo data stored in the first application which achieves a photo library may be input as an attached object of the second application creating the new E-mail. Moreover, the character data or the character string data described by the first application supporting the creation of the document may be input as the citation object of the second application creating the new E-mail.

First, when the user turns on the terminal device 100, the control unit 120 displays a home screen (e.g. a standby screen) on the display 100I after the lapse of the startup time, and waits until the control unit 120 receives the call operation of the first application as illustrated in FIG. 4 (NO in step S101). When the control unit 120 receives the call operation of the first application from the user via the touch panel 100H (YES in step S101), the control unit 120 starts up the first application (step S102) and displays the screen of the first application (step S103).

Thereby, the display 100I displays the screen 10 of the first application as illustrated in FIG. 5. The screen 10 includes a plurality of E-mails as received display items, and an operable image IM1 for starting up the second application creating a new mail. The received E-mails are managed with a list for each reception date and time.

Here, when the user performs the long depression operation designating a single E-mail by a finger FG as illustrated in FIG. 5, the control unit 120 receives the long depression operation (step S104) and creates the screen area 20 (step S105) as illustrated in FIG. 4. More specifically, when the control unit 120 receives the long depression operation different from an opening operation of the E-mail by the touch operation, and creates the opaque screen area 20 including the association information associating the E-mail designated by the long depression operation with a corresponding area. When the process of step S105 is completed, the control unit 120 displays the screen area 20 on the forefront surface of the display 100I (step S106). More specifically, the control unit 120 sets the screen area 20 to the floating state and displays the screen area 20 on the forefront surface of the display 100I.

As a result, the display 100I displays the screen area 20 in front of the screen 10 as illustrated in FIG. 6. Even when the user releases the finger FG from the designating E-mail, the display of the screen area 20 is maintained. The screen area 20 is set to the floating state, and the user sees as if the screen area 20 is floating. The floating state indicates a state where the screen area 20 is movably arranged on a display layer different from a display layer of the screen 10 as illustrated in FIG. 7. More specifically, the floating state indicates a state where the screen area 20 is movably arranged on the display layer (e.g. a display layer of the user side) higher than the display layer of the screen 10.

The screen area 20 is movable. Therefore, when the user performs the drag operation upward and downward on the screen area 20 by the finger FG as illustrated in FIG. 8, for example, the control unit 120 detects the drag operation. When the control unit 120 detects the drag operation, the control unit 120 changes a display position of the screen area 20 to a dragged position. When the user cannot see the information on the screen 10 due to the display position of the screen area 20, the user can change the display position of the screen area 20 and see the information on the screen 10. When the user further performs the long depression operation on another E-mail different from the E-mail on which the long depression operation has been performed, the display 100I displays the screen area 20 and another screen area (not shown) different from the screen area 20 without overlapping. Here, the direction of the above-mentioned drag operation is not limited to the vertical direction, but may be a horizontal direction or an oblique direction.

Next, as illustrated in FIG. 4, the control unit 120 waits until the call operation of the second application is received (NO in step S107). When the call operation of the second application is received (YES in step S107), the control unit 120 maintains a state where the screen area 20 is displayed on the forefront surface (step S108). Then, the control unit 120 starts up the second application (step S109), and displays the screen of the second application on the rear side of the screen area 20 (step S110).

Specifically, the process of steps S107 to S110 is explained with reference to FIGS. 9 and 10. When the user performs the touch operation on the image IM1 included in the screen 10 by the finger FG as illustrated in FIG. 9, the control unit 120 receives the call operation of the second application. When the control unit 120 receives the call operation of the second application, the control unit 120 maintains the state where the screen area 20 is displayed on the forefront surface and the display 100I displays the screen 30 of the second application on the rear side of the screen area 20 as illustrated in FIG. 10. The screen 30 is a screen for creating a new mail, and includes input fields of a destination, a subject and a mail body. For example, the user moves the display position of the screen area 20 to a side of the input field of the mail body by the drag operation in order to input the destination and the subject. When the user finishes inputting the destination and the subject, the user moves the display position of the screen area 20 to a side of the input field of the destination by the drag operation in order to input the mail body. When the user finishes inputting the mail body, the user moves the screen area 20 onto the input field of the email body and decides a pasting position in order to paste the e-mail associated with the screen area 20 on the input field of the mail body. Here, when the user performs an operation for shifting or swiping the screen 30 toward either right or left by the finger FG the control unit 120 changes the display of the screen 30 to the screen 10 and display the screen 10 while maintaining displaying the screen area 20 on the display 100I (see FIG. 9).

Here, as illustrated in FIG. 4, the control unit 120 waits until the operation to the screen area 20 is detected (NO in step S111). When the operation to the screen area 20 is detected (YES in step S111), the control unit 120 inputs the E-mail associated with the screen area 20 (step S112). After inputting the E-mail, the control unit 120 determines whether the operation period is shorter than a predetermined period (step S113).

When the operation period is not shorter than the predetermined period (NO in step S113), the control unit 120 maintains the display of the screen area 20 (step S114), and the procedure returns to step S111. That is, when the user performs the long depression operation on the screen area 20 by the finger FG as illustrated in FIG. 11, the control unit 120 inputs the E-mail associated with the screen area 20 to the screen 30, and maintains the display of the screen area 20 as illustrated in FIG. 12. A position where the E-mail is input is decided by the user. Thus, the display of the screen area 20 is maintained. Therefore, if the user further calls a third application (e.g. an application supporting the creation of a document) in addition to the second application, the screen area 20 can be also used for the third application. That is, the user can use the screen area 20 as an input for a plurality of applications.

On the contrary, when the operation period is shorter than the predetermined period (YES in step S113), the control unit 120 finishes the display of the screen area 20 (step S115) and the process is finished, as illustrated in FIG. 4. That is, when the user performs the touch operation on the screen area 20 by the finger FG as illustrated in FIG. 13, the control unit 120 inputs the E-mail associated with the screen area 20 to the screen 30, and finishes the display of the screen area 20 as illustrated in FIG. 14. As described above, the position where the E-mail is input is decided by the user. Thus, when the additional use of the screen area 20 is finished, the user performs the touch operation on the screen area 20, and hence the screen area 20 can be removed from the display layer above the screen 30.

As described above, the terminal device 100 includes the control unit 120 which performs various processes. Specifically, the control unit 120 receives a designation of one or more data from a group of data available in the first application in a state where the first application has been started up. The control unit 120 creates the screen area 20 including information associating each of the one or more data with a corresponding area, and displays the screen area 20 on the forefront surface of the display 100I. After the screen area 20 is displayed on the forefront surface, the control unit 120 receives the call operation of the second application, and displays the screen 30 of the second application on the rear side of the screen area 20 while maintaining the screen area 20 displayed on the forefront surface. When the control unit 120 detects the predetermined operation to the screen area 20 displayed on the forefront surface in the state where the screen 30 of the second application is displayed, the control unit 120 inputs data associated with the screen area 20 from which the predetermined operation is detected, to the second application as the process object. Thereby, it is possible to achieve more easily an operation which inputs data available in the first application to the second application. Specifically, the user can perform an intuitive screen operation which is easier to understand.

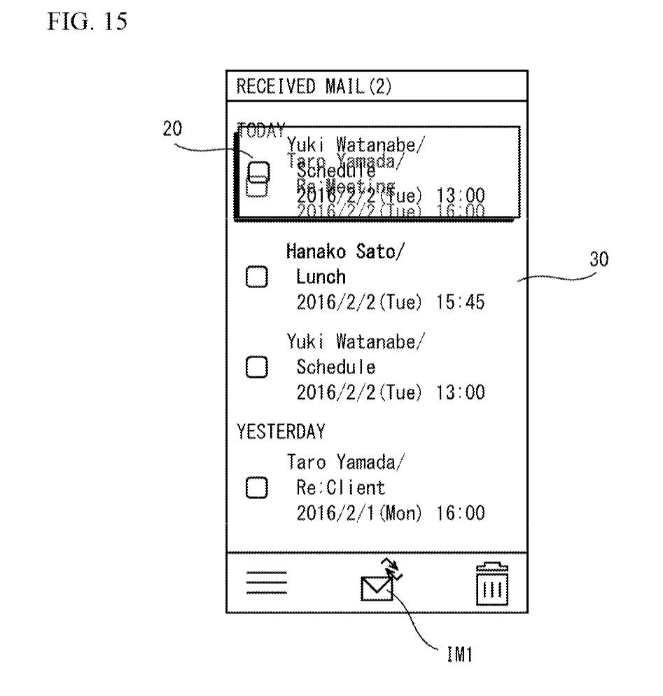

In the above-mentioned embodiment, the control unit 120 creates the opaque screen area 20 and displays the opaque screen area 20 on the forefront surface of the display 100I. For example, the control unit 120 may create a semitransparent screen area 20 and display the semitransparent screen area 20 on the forefront surface of the display 100I as illustrated in FIG. 15. Thereby, the user can confirm the information in the screen 30 hidden by the screen area 20.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various change, substitutions, and alterations could be made hereto without departing from the spirit and scope of the invention.

What is claimed is:

1. A display control method implemented by a computer, the method comprising:
receiving a designation of one or more data from a group of data available in a first application in a state where the first application has been started up;
creating a screen area including information associating each of the one or more data with a corresponding area, and displaying the screen area on a forefront surface of a display;
receiving, after the screen area is displayed on the forefront surface, a call operation of a second application, and displaying a screen of the second application on a rear side of the screen area while maintaining the screen area displayed on the forefront surface; and
inputting to the second application, when a predetermined operation to the screen area displayed on the forefront surface is detected in a state where the screen of the second application is displayed, the data associated with the screen area from which the predetermined operation is detected.

2. The display control method of claim 1, further comprising:
changing, when a drag operation to the screen area is detected while the screen area is being displayed on the forefront surface of the display, a display position of the screen area to a dragged position.

3. The display control method of claim 1, wherein
the screen area is displayed on the forefront surface in a semitransparent state.

4. The display control method of claim 1, wherein
when the predetermined operation is detected, the display of the screen area from which the predetermined operation is detected is finished.

5. The display control method of claim 1, wherein
after the predetermined operation is detected, the display of the screen area from which the predetermined operation is detected is maintained.

6. The display control method of claim 5, wherein
when another operation different from the predetermined operation is detected after the display of the screen area is maintained, the display of the screen area from which the predetermined operation is detected is finished.

7. A non-transitory computer readable medium storing a display control program, the program causing a computer to execute a process, the process comprising:
receiving a designation of one or more data from a group of data available in a first application in a state where the first application has been started up;
creating a screen area including information associating each of the one or more data with a corresponding area, and displaying the screen area on a forefront surface of a display;
receiving, after the screen area is displayed on the forefront surface, a call operation of a second application, and displaying a screen of the second application on a rear side of the screen area while maintaining the screen area displayed on the forefront surface; and
inputting to the second application, when a predetermined operation to the screen area displayed on the forefront surface is detected in a state where the screen of the second application is displayed, the data associated with the screen area from which the predetermined operation is detected.

8. A terminal device, comprising:
a memory; and
a processor coupled to the memory and the processor configured to:
receive a designation of one or more data from a group of data available in a first application in a state where the first application has been started up;
create a screen area including information associating each of the one or more data with a corresponding area, and display the screen area on a forefront surface of a display;
receive, after the screen area is displayed on the forefront surface, a call operation of a second application, and display a screen of the second application on a rear side of the screen area while maintaining the screen area displayed on the forefront surface; and
input to the second application, when a predetermined operation to the screen area displayed on the forefront surface is detected in a state where the screen of the second application is displayed, the data associated with the screen area from which the predetermined operation is detected.

9. The terminal device of claim 8, wherein
when a drag operation to the screen area is detected while the screen area is being displayed on the forefront surface of the display, the processor changes a display position of the screen area to a dragged position.

10. The terminal device of claim 8, wherein
the processor displays the screen area on the forefront surface in a semitransparent state.

11. The terminal device of claim 8, wherein
when the predetermined operation is detected, the processor finishes the display of the screen area from which the predetermined operation is detected.

12. The terminal device of claim 8, wherein
after the predetermined operation is detected, the processor maintains the display of the screen area from which the predetermined operation is detected.

13. The terminal device of claim 12, wherein
when another operation different from the predetermined operation is detected after the display of the screen area is maintained, the processor finishes the display of the screen area from which the predetermined operation is detected.
